(19) United States
(12) Patent Application Publication
(10) Pub. No.: US 2024/0265342 A1
(43) Pub. Date: Aug. 8, 2024

(54) SYSTEM FOR INVENTORY TRACKING

(71) Applicant: KoiReader Technologies, Inc., Dallas, TX (US)

(72) Inventors: Ashutosh Prasad, Dallas, TX (US); Vivek Prasad, Bengaluru (IN)

(73) Assignee: KoiReader Technologies, Inc., Dallas, TX (US)

(21) Appl. No.: 18/564,786

(22) PCT Filed: May 26, 2022
(86) PCT No.: PCT/US22/31070

§ 371 Date: Nov. 28, 2023

Related U.S. Application Data
(60) Provisional application No. 63/194,265, filed on May 28, 2021.

(51) Int. Cl. G06Q 10/087; G06Q 10/0833; G06V 20/40; G06V 20/52; G06V 20/62; G08B 13/24

(52) U.S. Cl. CPC G06Q 10/087; G06Q 10/0833; G06V 20/44; G06V 20/52; G06V 20/625; G08B 13/2462

(57) ABSTRACT

Techniques are described for providing an inventory management system that tracks inventory each time an item or transport handling unit is moved within a facility. In some cases, the system may include sensors mounted with a field of view associated with a forklift implement and processed to determine an identity and location of each collection and delivery event performed by the forklift operator.

### CROSS-REFERENCE TO RELATED APPLICATIONS

This application is a U.S. national stage application under 35 USC § 371 of International Application No. PCT/US22/31070 filed on May 26, 2022 and entitled “SYSTEM FOR INVENTORY TRACKING,” which claims priority to U.S. Provisional Application No. 63/194,265 filed on May 28, 2021 the entire contents of which are incorporated herein by reference.

### BACKGROUND

Storage facilities, such as shipping yards, processing plants, warehouses, distribution centers, ports, yards, and the like, may store vast quantities of inventory over a period of time. Monitoring the inventory is typically a manual task performed as part of weekly, monthly, and yearly audits. These audits are often time consuming and may be prone to errors. Additionally, between audits inventory may be lost or otherwise misplaced resulting in logistical delays and the like.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of an inventory system and for providing inventory tracking capabilities and other safety features.

FIG. 2 is a flow diagram illustrating an example process associated with pick or collection events according to some implementations.

FIG. 3 is a flow diagram illustrating an example process associated with delivery events according to some implementations.

FIG. 4 is a flow diagram illustrating an example process associated with a routing vehicles within a facility according to some implementations.

FIG. 5 is an example sensor system that may implement the techniques described herein according to some implementations.

FIG. 6 is an example inventory management system that may implement the techniques described herein according to some implementations.

FIG. 7 is an example pictorial view associated with the systems of FIGS. 1-6 according to some implementations.

FIG. 8 is an example pictorial view associated with the systems of FIGS. 1-6 according to some implementations.

FIG. 9 is another example pictorial view associated with the systems of FIGS. 1-6 according to some implementations.

FIG. 10 is another example pictorial vie associated with the systems of FIGS. 1-6 according to some implementations.

FIG. 11 is another example pictorial view associated with the systems of FIGS. 1-6 according to some implementations.

FIG. 12 is another example pictorial view associated with the systems of FIGS. 1-6 according to some implementations.

### DETAILED DESCRIPTION

Discussed herein is a system for monitoring, tracking, arranging, and ordering inventory stored within a facility, such as a storage facility, warehouse, yard, or the like as well as during shipping and delivery. For example, the inventory management system, discussed herein, may include an inventory management system, warehouse management system, asset management system, facility management system, supply chain management system, and/or the like. The inventory management system may include a plurality of sensor systems communicatively coupled to a central or edge processing system, such as a cloud-based inventory management service. For example, the sensor systems may be associated with a forklift, pallet truck, pallet jack, bump trucks, laser guided vehicle (LGV), autonomous vehicle, helmet or human worn system, and the like.

In some cases, the system may also include various surface (e.g., wall and/or ceiling) mounted sensor systems. The sensors may be configured to detect identifiers, such as RFID UWB or BLE tags, bar codes, alpha/numerical codes, and the like, associated with packages and/or transport handling unit (THU) including, but not limited to, as pallets, bins, unit load devices (ULDs), ocean containers, any object that may carry or otherwise transport an inventory item, and the like.

In some cases, the sensors may be mounted with a field of view in line with the implement or forks of a forklift or other vehicle. In this manner, the inventory management system may receive sensor data associated with the field of view of the forklift implements as the forklift operator aligns, pickups, and delivers the THU. In some cases, the sensor system may be integral to the forklift, such as in the case of an autonomous forklift, while in other cases, the sensor system may be coupled to the forklift, such as nearby the implement.

For example, as the forklift approaches the THU the sensor data having the field of view associated with the implement may be sent to the inventory management system. The inventory management system may first determine that the forklift is in the process of collecting or picking up a THU based on the determination that the THU, shelving, and/or packages on the THU are increasing in size within a scene of associated with the sensor data.

As the THU is being collected by the forklift or other vehicle, the inventory management system may also identify a position of entry or opening in the THU for receiving the implements or forks, such as a notch, hole, and the like, based on the sensor data. The inventory management system may also determine in substantial real-time that the forks of the implement are correctly aligned (e.g., aligned horizontally and vertically) with respect to the openings to safely collect and pick up the THU. For instance, it is common that inventory is damaged by a forklift operator when collecting THU from shelfs, partially high shelfs, in which the operator is unable to clearly view the THU and the implement. In this example, the inventory management system may determine if the implement is correctly aligned and if so allow the operator to collect the THU. However, if the inventory management system determines the alignment is incorrect or likely to cause an impact with the THU and/or the inventory associated with the THU, the inventory management system may generate an alert to an autonomous systems (such as a vehicle) and/or the operator to halt the collection operations. For example, the alert may be output by a speaker, displayed an electronic device, and/or a display associated with the forklift. In some cases, the alert may include instructions to assist with alignment, such as raise implement, lower implement, and the like.

The inventory management system may also determine an identity of the THU and/or the packages on the THU based at least in part on one or more identifiers within the field of view and associated with the THU and the contents of the THU. For example, the shelfing and/or floor space adjacent to the THU may include a license plate or other identifiers that may be detected within the sensor data and usable by the inventory management system to recognize and classify the THU and/or the packages associated therewith. In other cases, the inventory management system may locate and track identifiers on the THU and/or individual packages. For example, the THU and/or individual packages may include a bar code, QR code or other identifiers that may be detected in the sensor data. In some cases, the identifiers may be electric, in the form of, for example, an RFID or UWB or BLE tag or other wireless communicated technology.

Upon identification, the inventory management system may determine if the THU is the expected asset and if not send an alert to a system (e.g., a monitoring systems, sensor device, vehicle, and the like), an operator of the vehicle, and/or a supervisor. For example, if the identifiers do not match the expected identifiers, the inventory management system may cause a speaker to output an audible alert to the operator. In other examples, the inventory management system may cause a visible alert to display on an electronic device, such as a smartphone associated with the operator and/or a display associated with the forklift. The alert may also be tactile such as a vibration or the like associated with the electronic device associated with the operator. In some cases, the system may generate an exception report associated with the alert that may be stored or provided, for example, to the controls of an autonomous vehicle or system. In this manner, the inventory management system may actively prevent misplacement of THUs and the inventory associated therewith, thereby reducing and/or eliminating the necessity for weekly, monthly and/or yearly audits required by conventional inventory systems.

The inventory system may also receive sensor data associated with a delivery of the THU to a destination. In some cases, the inventory management system may receive sensor data associated with the delivery. The inventory management system may determine that the sensor data is associated with a delivery by determining a direction of movement of the implement based on the sensor data. For example, the inventory management system may determine the delivery as the THU and inventory associated therewith may decrease in size within the scene as the forklift backs away from the THU after placement. In other examples, the inventory management system may determine a change in position of one or more objects detected within the scene. At this time, the inventory management system may again verify the identity of the THU and/or the inventory associated there with. The inventory management system may also determine the delivery location based on location indicators, such as a license plate associated with the floor area or additional shelving at which the THU was placed. Again, in this manner, the inventory management system may actively prevent misplacement of THUs and the inventory associated therewith, thereby further reducing and/or eliminating the necessity for weekly, monthly and/or yearly audits required by conventional inventory systems.

In some examples, the inventory management system may also determine or otherwise estimate a number of packages or amount of inventory collected and/or delivered by a forklift using the implement sensor data. For example, the inventory management system may segment the sensor data to identify individual packages, units, or items and/or identifiers associated therewith. The inventory management system may then estimate the unit number based on the size of the individual units, a known size (e.g., length and/or width) of the THU, the type of THU, and a height associated with the shelfs and/or the units associated the THU.

In some cases, the inventory management system may also receive sensor data from one or more sensors affixed through the facility. For example, sensors may be affixed along isles of the shelving, at various ceiling locations (such as above a floor space, processing areas, conveyor belts, or other workspaces), at towers or mounting positions (such as along bay doors, floor space, or other open spaces). In one specific example, the sensor may be placed at corners to assist with routing multiple vehicles. For instance, the inventory management system may receive sensor data associated with a corner and determine two opposing vehicles are approaching. The inventory management system may send an alert to the vehicles, other autonomous systems, and/or the operator of either or both of the vehicles with instructions on which vehicle should halt and which vehicle should proceed to prevent accidents and the like. In some examples, the inventory management system may also aggerate the sensor data from multiple sensors in order to determine location, size, inventory count and the like associated with individual units and/or THUs. In some cases, the sensor data may be received from one or both of the vehicles, such as in the case of a BLU, RFID, or UWB sensor detecting the proximity of the vehicles.

In some implementations, the inventory management system may also receive sensor data from a helmet, vest, or other worn sensor system. For instance, in some cases, inventory may be stored in bins or buckets. In these instances, the contents of the bins are often obstructed from the field of view of the sensors by lids, covers, other bins, other THUs, shelving, and the like. By incorporating the sensor data from staff based sensors, the inventory management system may determine inventory counts, picks, and placements with respect to the bins at the time of the access event. As an illustrated example, if an operator opens and removes a unit from a bin, the body or worn sensor may capture data representative of the pick as well as the content of the bin. The inventory management system may utilize this data to update the inventory count associated with the bin (e.g., subtract the picked items and/or process the data associated with the bin content to estimate a remaining number of units).

In some examples, the inventory management system may process the sensor data using one or more machine learned models. As described herein, the machine learned models may be generated using various machine learning techniques. For example, the models may be generated using one or more neural network(s). A neural network may be a biologically inspired algorithm or technique which passes input data (e.g., image and sensor data captured by the IoT computing devices) through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from the captured sensor and/or image data. In some cases, the neural network may be a trained network architecture that is end-to-end. In one example, the machine learned models may include segmenting and/or classifying extracted deep convolutional features of the sensor and/or image data into semantic data. In some cases, appropriate truth outputs of the model in the form of semantic per-pixel classifications (e.g., vehicle identifier, container identifier, driver identifier, and the like).

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

In some examples, the sensor system installed with respect to the implement of the forklift may include one or more multiple IoT devices. The IoT computing devices may include a smart network video recorder (NVR) or other type of EDGE computing device. Each IoT device may also be equipped with sensors and/or image capture devices, such as visible light image systems, infrared image systems, radar based image systems, LIDAR based image systems, SWIR based image systems, Muon based image systems, radio wave based image systems, and/or the like. In some cases, the IoT computing devices may also be equipped with models and instructions to capture, parse, identify, and extract information associated with a collection or delivery event, as discussed above, in lieu of or in addition to the cloud-based services. For example, the IoT computing devices and/or the cloud-based services may be configured to perform segmentation, classification, attribute detection, recognition, data extraction, and the like.

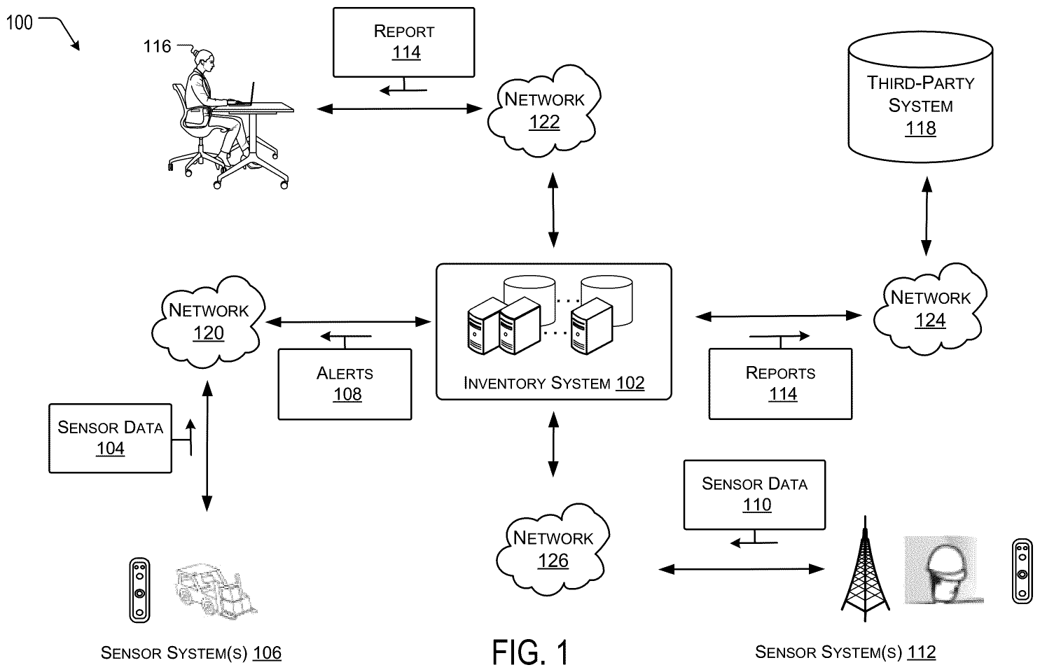

FIG. 1 is an example block diagram 100 of an inventory system 102 and for providing inventory tracking capabilities and other safety features. For example, the inventory management system 102 may receive sensor data 104 from various devices, generally indicated by 106. The devices may include one or more IoT devices or sensors installed at fixed locations throughout a facility and/or associated with a vehicle implement, such as a forklift, surface mounted, operator mounted, or the like.

In some cases, the sensor system associated with the forklift may include image devices, recording and data storage devices or systems as well as gyroscopes, accelerometers, inertial measurement units (IMUs) and the like. During operations, the sensors may collect data along with the image or video data from image devices during picking, put away, replenishment. The image or video data may be sent to an EDGE computing device over wireless interface (such as stream data) to generate audit, safety, and behavior analytics. The generated data may then be used to produce predictive scores that will be associated with the forklift operator (which operator is most likely to cause accidents based on their forklift operation and driving behavior). The audit, safety, and behavioral analysis can also be used in real-time to provide feedback to the operator and the operations supervisor about a potential safety risk. This alert may be provided via sound/voice or visual display or signal, as discussed below.

In some cases, the sensor data 104 may include image data associated with a field of view of the sensor 106 associated with the implement of the forklift. The inventory management system 102 may utilize the sensor data having the field of view associated with the implement to determine if the forklift is in the process of collecting or picking up a THU based on the determination that the THU, shelving, and/or packages on the THU are increasing in size within the captured scene. The inventory management system 102 may also identify a position of the openings of the THU based on the sensor data, as the THU is being collected. For example, the inventory management system 102 may also determine that the forks of the implement are correctly aligned (e.g., aligned horizontally and vertically) with respect to the openings of the THU to safety collect and pick up the THU. In this manner, the inventory management system 102 may prevent damage to the facility (e.g., the shelving), the THU, and the contents of the THU.

If the inventory management system 102 determines the alignment is incorrect or likely to cause an impact with the THU and/or the inventory associated with the THU, the inventory management system 102 may generate an alert 108 to the forklift (such as a control signal) and/or the operator of the forklift associated with the sensor 106. The alert 108 may be instructions or control signals to halt the collection operation. For example, the alert 108 may be output by a speaker, displayed an electronic device, a display associated with the forklift, a mobile phone, and/or the like. In some cases, the alert 108 may include instructions to assist with alignment, such as raise implement, lower implement, and the like.

The inventory management system 102 may also determine an identity of the THU and/or the contents of the THU based at least in part on one or more identifiers within the field of view of the sensor 106 and associated with the THU and the contents of the THU. For example, as discussed above, the shelfing and/or floor space adjacent to the THU may include a license plate or other identifiers that may be detected within the sensor data 104 and usable by the inventory management system 102 to recognize and classify the THU and/or the contents associated therewith. In other cases, the inventory management system 102 may locate and track identifiers on the THU and/or individual packages/content. As an illustrative example, the THU and/or individual packages may include a bar code, QR code, or other identifiers that may be detected in and/or extracted from the sensor data 104. In some cases, the identifiers may be electric, in the form of, for example, an RFID tag, Bluetooth® low energy (BLE) signal, or other wireless communicated technology.

Upon identification, the inventory management system 102 may determine if the THU is the expected asset and, if not, send additional alerts 108 to the vehicle and/or an operator of the forklift associated with the sensor 106. For example, if the identifiers do not match the expected identifiers, the inventory management system 102 may again cause a speaker to output an audible alert 108 to the operator. In other examples, the inventory management system 102 may cause a visible alert 108 to display on an electronic device, such as a smartphone associated with the operator and/or a display associated with the forklift. The additional alerts 108 may also be tactile such as a vibration or the like associated with the electronic device associated with the operator. In this manner, the inventory management system 102 may actively prevent misplacement of THU and the inventory associated therewith, thereby reducing and/or eliminating the necessity for weekly, monthly and/or yearly audits required by conventional inventory systems.

The inventory management system 102 may also receive sensor data 104 associated with a delivery of the THU to a destination. In some cases, the inventory management system 102 may determine that the sensor data 104 is associated with a delivery as the THU and inventory associated therewith may decrease in size within the scene as the forklift backs away from the THU after placement. At this time, the inventory management system 102 may again verify the identity of the THU and/or the associated the inventory. The inventory management system 102 may also determine the delivery location based on location indicators, such as a license plate associated with the floor area or additional shelving at which the THU was placed, within represented within the sensor data 104.

In some examples, the inventory management system 102 may also determine or otherwise estimate a number of units or amount of inventory collected and/or delivered by the corresponding forklift associated with the sensor data 104. For example, the inventory management system 102 may segment the sensor data to identify individual package, units, or items and/or the associated identifiers. The inventory management system 102 may then estimate the unit number based on the size of the individual units, a known size (e.g., length and/or width) of the THU, the type of THU, and a height associated with the shelfs, the units associated the THU, and the like.

In some cases, the inventory management system may also receive sensor data 110 from one or more sensors affixed through the facility. For example, sensors 112 may be affixed along isles of the shelving, at various ceiling locations (such as above a floor space, processing areas, conveyor belts, or other workspaces), at towers or mounting positions (such as along bay doors, floor space, or other open spaces). In one specific example, the sensors 112 may be placed at corners to assist with multiple vehicle routing. For instance, the inventory management system 102 may receive sensor data 110 associated with a corner and determine two opposing vehicles are approaching. The inventory management system 102 may send an alert 108 to the either or both vehicles (such as control signals) and/or to the operator of either or both of the vehicles with instructions on which vehicle should halt and which vehicle should proceed to prevent accidents and the like. In some examples, the inventory management system 102 may also aggregate the sensor data 104 and/or the sensor data 110 from multiple sensors, such as sensors systems 106 and 112, in order to determine location, size, inventory count and the like associated with individual units and/or THUs.

In some implementations, the inventory management system 102 may also receive sensor data 110 from helmet, vest, or other sensors 112 worn by operators and/or facility staff. For instance, in some cases, inventory may be stored in bins, buckets, or other containers. In these instances, the contents of the bins are often obstructed from the field of view of the sensors by lids, covers, other bins, other THUs, shelving, and the like. By incorporating the sensor data 110 from staff based sensors 112, the inventory management system 102 may determine inventory counts, picks, and placements with respect to the bins at the time of the access event. As an illustrated example, if an operator opens and removes a unit from a bin, the body or worn sensor 112 may capture the sensor data 110 representative of the pick as well as the content of the bin. The inventory management system 102 may utilize the sensor data 110 to update the inventory count associated with the bin (e.g., subtract the picked items and/or process the data associated with the bin content to estimate a remaining number of units).

In some cases, the inventory management system 102 may also utilize the sensor data 104 and/or 110 to generate reports 114 for a facility operator 116 and/or third-parties 118, such as a buyer, owner, or seller of the inventory. In some cases, the reports 114 may be used in lieu of or in addition to manual audits. For example, the reports 114 may include inventory counts, locations, processing data associated with the inventory (e.g., packaging, placement, picking, put away, replenishment, stickering, labeling, relabeling, processing, item handling, pallet build, loading, unloading, and the like), as well as other information.

In the current example, the sensor data 104, the sensor data 110, the alerts 108, and the reports 114 as well as other data may be transmitted between various systems using networks, generally indicated by 120-126. The networks 120-126 may be any type of network that facilitates compunction between one or more systems and may include one or more cellular networks, radio, WiFi networks, short-range or near-field networks, infrared signals, local area networks, wide area networks, the internet, and so forth. In the current example, each network 120-126 is shown as a separate network but it should be understood that two or more of the networks may be combined or the same.

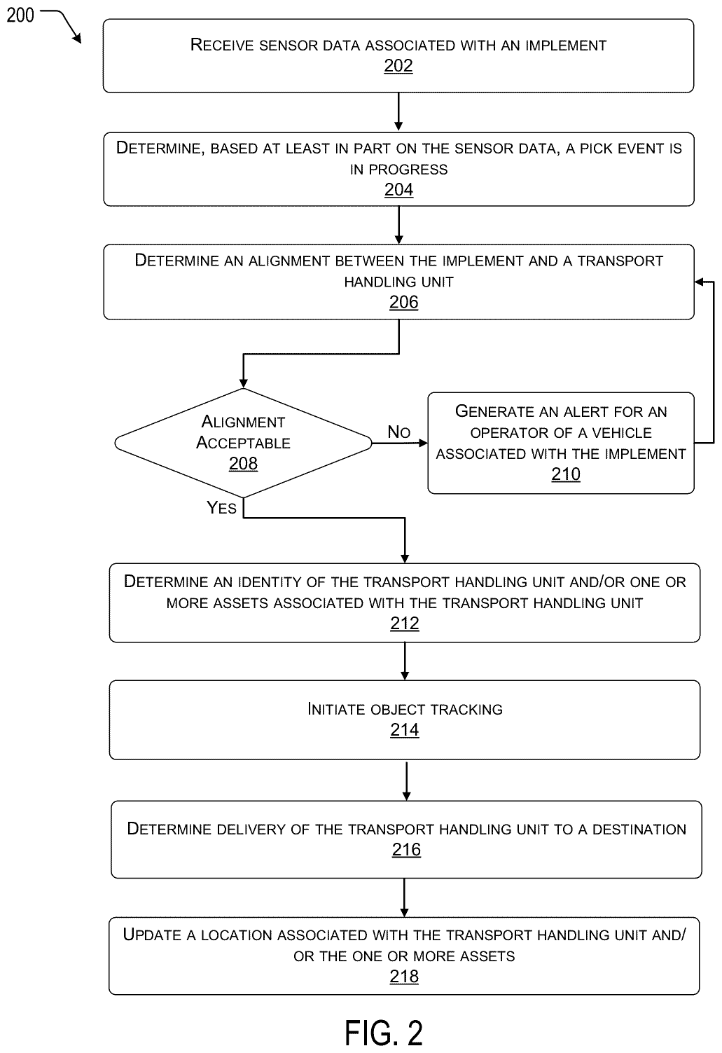

FIGS. 2-4 are flow diagrams illustrating example processes associated with the inventory management system discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processor(s), perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 2 is a flow diagram illustrating an example process 200 associated with pick or collection events according to some implementations. As discussed herein, the inventory system may be configured to assist with inventory tracking as well as provide safety alerts to operators of vehicles, such as forklifts.

At 202, the inventory management system may receive sensor data associated with an implement of a vehicle. For example, the sensor data may be received from a sensor system having a field of view corresponding to the implement of a forklift. In some cases, the sensor system may be configured to raise and lower with the implement and may include a rechargeable power source that is independent from the forklift. In some cases, the rechargeable power source may be configured for wireless charging or a wired charging system when the forklift is docked, packed, or otherwise not in use. The sensor data may include image data associated with the field of view including THU and associated contents.

At 204, the inventory management system may determine, based at least in part on the sensor data, a pickup event is in progress. For example, the inventory management system may determine the THU, shelving, and/or contents of the THU are increasing in size within the scene representing the sensor data or a direction of travel based on relative positions of objects in the scene in successive frames. In other cases, the operator of the forklift may provide a user input indicating that a pickup event is in progress, such as via an associated electronic device.

At 206, the inventory management system may determine an alignment between the implement and the THU. For example, the inventory management system may detect the openings in the THU and an estimated trajectory of the implement to determine the alignment. In some cases, the inventory management system may generate bounding boxes associated with the openings and determine if the alignment or estimated position of the implement falls within a threshold of the bounding box.

At 208, the inventory management system may determine if the alignment is acceptable (e.g., within the thresholds). If the alignment is not acceptable, the process 200 advances to 210. At 210, the inventory management system may generate an alert for an operator of the vehicle associated with the implement. For example, the alert may be output by a speaker, displayed on an electronic device, and/or a display associated with the forklift. In some cases, the alert may include instructions to assist with alignment, such as raise implement, lower implement, and the like. The process 200 then returns to 206 to re-determine the alignment between the implement and the THU.

However, if the alignment is acceptable, the process 200 proceeds to 212. At 212, the inventory management system may determine an identity of the THU and/or one or more assets associated with the THU. For example, the inventory management system may analyze and extract identifiers from the sensor data in order to determine an identity of the THU and/or the assets.

At 214, the inventory management system may initiate object tracking. For example, the inventory management system may track the THU and/or the identified assets. In some cases, when the THU is engaged with the implement, the field of view of the on board sensor system may be obstructed. In these cases, the inventory management system may track the position of the forklift, THU, and/or the assets based at least in part on sensor data from other sensors positioned about the facility at fixed locations, as discussed above.

At 216, the inventory management system may determine delivery of the THU and/or the assets to a destination. For example, the forklift may deliver the THU to a floor location, processing location (such as a conveyor belt, work region, assembly region, loading or unloading region, or the like). In some cases, the inventory management system may process the sensor data received to determine a license plate associated with the destination. The inventory management system may also confirm the identity of the THU and/or the assets as the THU is removed or released from the implement using sensor data from the on board sensor system.

At 218, the inventory management system may update a location associated with the THU and/or the one or more assets. The inventory management system may also generate a report or delivery alert for a facility operator, manager, or the like.

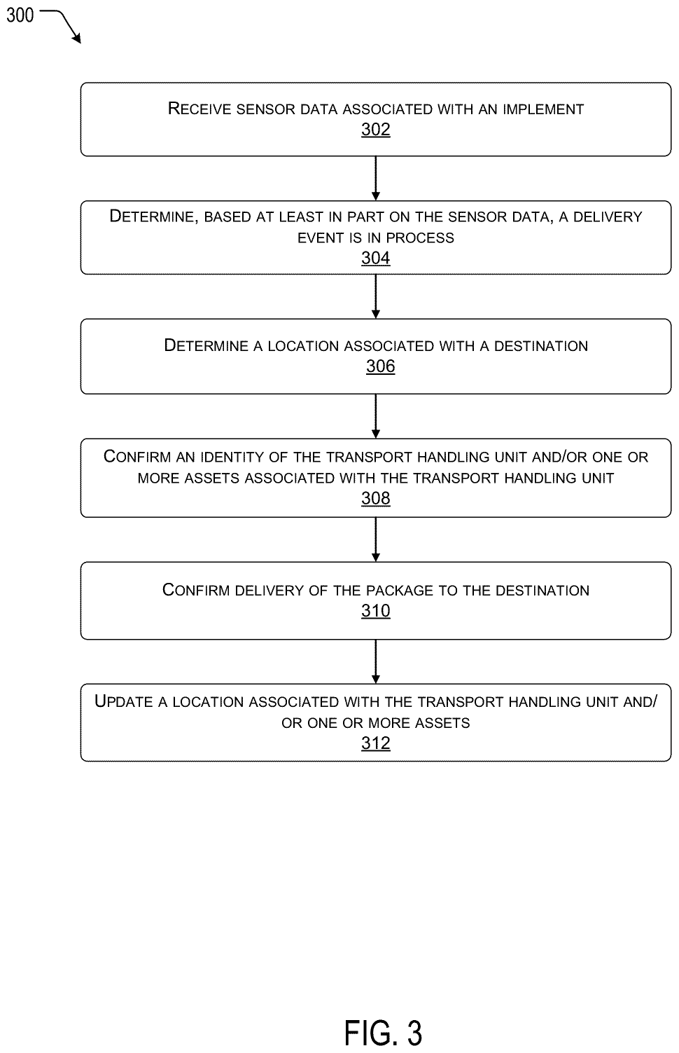

FIG. 3 is a flow diagram illustrating an example process 300 associated with delivery events according to some implementations. As discussed herein, the inventory system may be configured to assist with inventory tracking as well as provide safety alerts to operators of vehicles, such as forklifts.

At 302, the inventory management system m may receive sensor data associated with an implement of a vehicle. For example, the sensor data may be received from a sensor system having a field of view corresponding to the implement of a forklift. The sensor data may include image data associated with the field of view including the THU and associated contents.

At 304, the inventory management system may determine, based at least in part on the sensor data, a delivery event is in progress. For example, the inventory management system may determine the THU, shelving, and/or contents of the THU are decreasing in size within the scene representing the sensor data or a direction of travel away from the THU based on relative positions of objects in the scene in successive frames. In other cases, the operator of the forklift may provide a user input indicating that a pickup event is in progress, such as via an associated electronic device.

At 306, the inventory management system may determine a location associated with a destination. For example, the inventory management system may process the sensor data received to determine a license plate associated with the destination.

At 308, the inventory management system may confirm an identity of the THU and/or the assets as the THU is removed or released from the implement using sensor data from the on board sensor system.

At 310, the inventory management system may confirm delivery of the package to the destination. For example, the inventory management system may confirm delivery based on detecting within the sensor data that the THU is no longer engaged with the implement and that the detected location matches an expected delivery location (e.g., the THU was delivered to the correct location). In some cases, if the detected location does not match the expected delivery location, the inventory management system may generate an alert to notify the vehicle operator that the delivery was erroneous, thereby preventing inventory from being misplaced at the time of delivery.

At 312, the inventory management system may update a location associated with the THU and/or the assets. For example, in an inventory management system may store the number and/or location of the assets within the facility. In some cases, the inventory management system may generate a report or alert notifying a facility operator, manager, or the like as to the updated location.

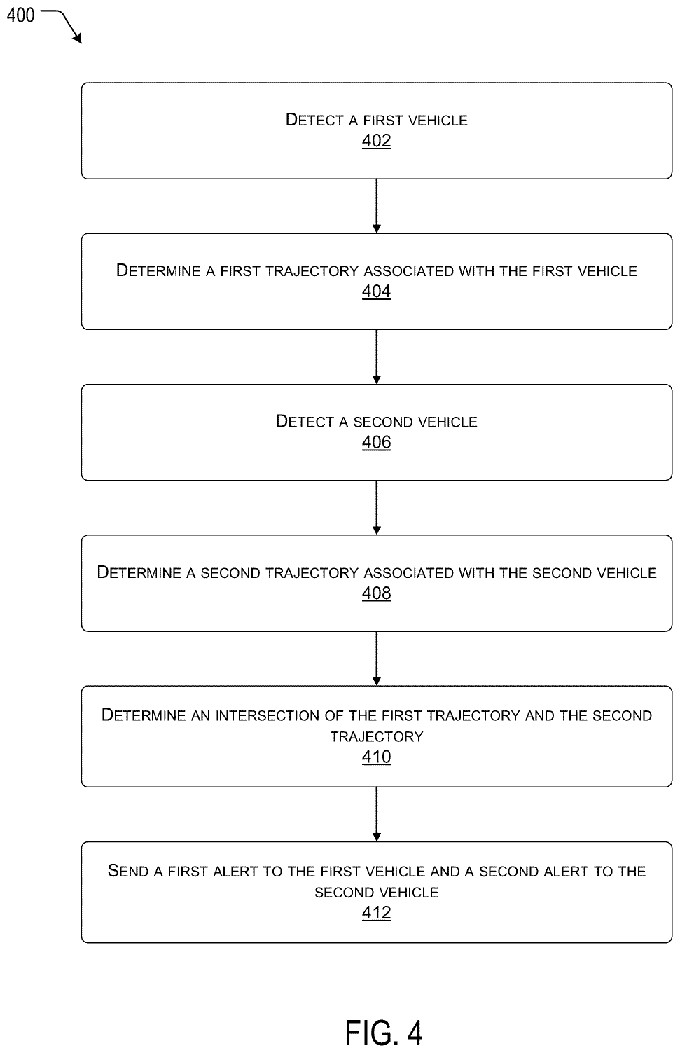

FIG. 4 is a flow diagram illustrating an example process 400 associated with a routing vehicles within a facility according to some implementations. For example, often multiple forklifts are operating within a facility. The forklift operators often have limited visibility due to the high racks or shelving or path cross-sections typically utilized to maximum storage capacity and/or the presence of a THU engaged with the implement. In this example, the inventory management system may assist with routing the forklifts to prevent accidental impacts between the forklifts, individuals, and/or other structures in the facility.

At 402, the inventory management system may detect a first vehicle, such as within sensor data captured by one or more sensors systems. The sensor systems may be associated with a fixed location, individual vehicles, and/or individual operators.

At 404, the inventory management system may determine a first trajectory associated with the first vehicle. For example, the inventory management system may determine the trajectory based on a current position of the vehicle, detected characteristics, such as velocity, direction of travel, and the like, as well as based on known information about the vehicle, such as destination location, current load, and the like.

At 406, the inventory management system may detect a second vehicle, such as within the sensor data captured by one or more the sensors system, and, at 408, the inventory management system may determine a first trajectory associated with the first vehicle. For example, the inventory management system again may determine the trajectory based on a current position of the vehicle, detected characteristics, such as velocity, direction of travel, and the like, as well as based on known information about the vehicle, such as destination location, current load, and the like.

At 410, the inventory management system may determine an intersection of the first trajectory and the second trajectory or other potential impact event associated with the first vehicle and the second vehicle. For example, the inventory management system may determine both vehicles may arrive at a corner concurrently based on the first trajectory and second trajectory.

At 412, the inventory management system may send a first alert to the first vehicle and a second alert to the second vehicle. As discussed above, the alerts may include instructions such as halt, decelerate, change route, and the like. In some cases, the alerts may be presented to the operators via a display of the vehicle or other electronic device associated with the operator. In other cases, the alerts may be audible or the like.

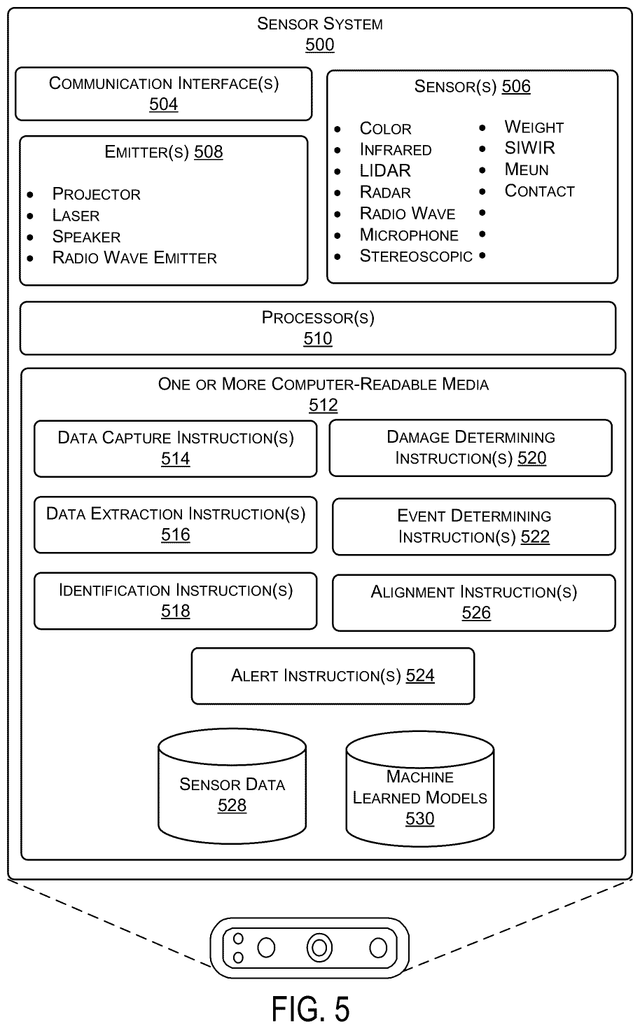

FIG. 5 is an example sensor system 500 that may implement the techniques described herein according to some implementations. The sensor system 500 may include one or more communication interface(s) 502 (also referred to as communication devices and/or modems), one or more sensor(s) 504, and one or more emitter(s) 506.

The sensor system 500 may include one or more communication interfaces(s) 502 that enable communication between the system 500 and one or more other local or remote computing device(s) or remote services, such as an inventory management system of FIGS. 1-4. For instance, the communication interface(s) 502 can facilitate communication with other proximity sensor systems, a central control system, or other facility systems. The communications interfaces(s) 502 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The one or more sensor(s) 504 may be configured to capture the sensor data 526 associated with an exterior and/or interior of a vehicle, chassis, container, and/or content of the container. In at least some examples, the sensor(s) 504 may include thermal sensors, time-of-flight sensors, location sensors, LIDAR sensors, SWIR sensors, radar sensors, sonar sensors, infrared sensors, cameras (e.g., RGB, IR, intensity, depth, etc.), Muon sensors, microphone sensors, environmental sensors (e.g., temperature sensors, humidity sensors, light sensors, pressure sensors, etc.), and the like. In some examples, the sensor(s) 504 may include multiple instances of each type of sensors. For instance, camera sensors may include multiple cameras disposed at various locations.

The sensor system 500 may also include one or more emitter(s) 506 for emitting light and/or sound. By way of example and not limitation, the emitters in this example include light, illuminators, lasers, patterns, such as an array of light, audio emitters, and the like.

The sensor system 500 may include one or more processors 508 and one or more computer-readable media 510. Each of the processors 508 may itself comprise one or more processors or processing cores. The computer-readable media 510 is illustrated as including memory/storage. The computer-readable media 510 may include volatile media (such as random access memory (RAM)) and/or nonvolatile media (such as read only memory (ROM), Flash memory, optical disks, magnetic disks, and so forth). The computer-readable media 510 may include fixed media (e.g., GPU, NPU, RAM, ROM, a fixed hard drive, and so on) as well as removable media (e.g., Flash memory, a removable hard drive, an optical disc, and so forth). The computer-readable media 510 may be configured in a variety of other ways as further described below.

Several modules such as instructions, data stores, and so forth may be stored within the computer-readable media 510 and configured to execute on the processors 508. For example, as illustrated, the computer-readable media 510 stores data capture instructions 512, data extraction instructions 514, identification instructions 516, damage inspection instructions 518, event determining instructions 520, alignment instructions 522, alert instructions 524, as well as other instructions, such as an operating system. The computer-readable media 510 may also be configured to store data, such as sensor data 526 and machine learned models 528 as well as other data.

The data capture instructions 512 may be configured to utilize or activate the emitters 506 and/or the sensor systems 504 to capture sensor data 526 associated with a THU, region of the facility, and/or the various inventory. The captured sensor data 526 may then be stored and/or transmitted or streamed to an inventory managed system, as discussed herein.

The data extraction instructions 514 may be configured to extract, segment, classify objects represented within the sensor data 526. For example, the data extraction instructions 514 may segment and classify each unit present on a THU as well as the openings of the THU and other objects or features within the sensor data 526. In some cases, the data extraction instructions 514 may utilize the machine learned models 528 to perform extraction, segmentation, classification, and the like.

The identification instructions 516 may be configured to determine an identity of the THU, assets associated with the THU, region of the facility and the like. For example, the identification instructions 516 may utilize one or more machine learned models 528 with respect to the sensor data 526 and/or the extracted data to determine the identity of the THU, location, and/or assets of a THU as discussed above.

The damage inspection instructions 518 may be configured to process the sensor data 526 to identify damage associated with assets and/or a THU. For example, the damage inspection instructions 518 may detect damage using the machine learned models then compare the damage detected with any known damage to determine if the damage was received while the THU was being moved. In some cases, the damage inspection instructions 518 may also rate the damage, for instance, using a severity rating.

The event determining instructions 520 may be configured to process the sensor data 526 to determine if a pickup or delivery event is in process and to cause the processors 508 to perform various operations based on the determination of the event type. For example, the processors 510 may perform operations associated with the alignment instructions 524 in the occurrence of a pickup event.

The alignment instructions 522 may be configured to process the sensor data 526 to determine if the implement of the vehicle is correctly alignment with the openings of the THU to thereby preventing inadvertent contact with the contents of the THU. In this manner, the alignment instructions 522 may assist with reducing or otherwise preventing damage to inventory within the facility.

The alert instructions 524 may be configured to alert or otherwise notify vehicle operators and/or facility operators in response to the sensor data 526 or signals generated by the data extraction instructions 514, the identification instructions 516, the damage inspection instructions 518, the alignment determining instructions 524, and/or a combination thereof. For example, the alert instructions 522 may cause instructions to be presented to a vehicle operator in response to a misalignment of the implement with the openings of the THU.

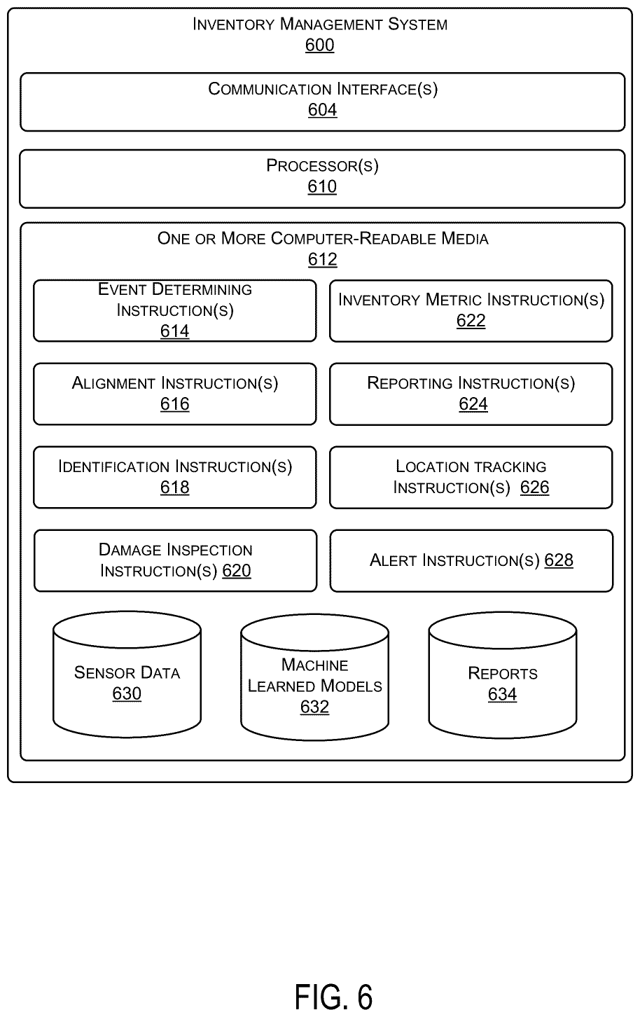

FIG. 6 is an example inventory management system 600 that may implement the techniques described herein according to some implementations. The inventory management system 600 may include one or more communication interface(s) 602 (also referred to as communication devices and/or modems). The one or more communication interfaces(s) 602 may enable communication between the system 600 and one or more other local or remote computing device(s) or remote services, such as sensors system of FIG. 5. For instance, the communication interface(s) 602 can facilitate communication with other proximity sensor systems, a central control system, or other facility systems. The communications interfaces(s) 602 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The inventory management system 600 may include one or more processors 610 and one or more computer-readable media 612. Each of the processors 610 may itself comprise one or more processors or processing cores. The computer-readable media 612 is illustrated as including memory/storage. The computer-readable media 612 may include volatile media (such as random access memory (RAM)) and/or nonvolatile media (such as read only memory (ROM), Flash memory, optical disks, magnetic disks, and so forth). The computer-readable media 612 may include fixed media (e.g., GPU, NPU, RAM, ROM, a fixed hard drive, and so on) as well as removable media (e.g., Flash memory, a removable hard drive, an optical disc, and so forth). The computer-readable media 612 may be configured in a variety of other ways as further described below.

Several modules such as instructions, data stores, and so forth may be stored within the computer-readable media 612 and configured to execute on the processors 610. For example, as illustrated, the computer-readable media 612 stores event determining instructions 614, alignment instructions 616, identification instructions 618, damage inspection instructions 620, inventory metric instructions 622, reporting instructions 624, location tracking instructions 626, alert instructions 628 as well as other instructions, such as an operating system. The computer-readable media 612 may also be configured to store data, such as sensor data 630, machine learned models 632, and reports 634 as well as other data.

The event determining instructions 614 may be configured to process the sensor data 630 to determine if a pickup or delivery event is in process and to cause the processors 610 to perform various operations based on the determination of the event type. For example, the processors 610 may perform operations associated with the alignment instructions 616 in the occurrence of a pickup event.

The alignment instructions 616 may be configured to process the sensor data 630 to determine if the implement of the vehicle is correctly alignment with the openings of the THU to thereby prevent inadvertent contact with the contents of the THU. In this manner, the alignment instructions 616 may assist with reducing or otherwise preventing damage to inventory within the facility.

The identification instructions 618 may be configured to determine an identity of the THU, assets associated with the THU, region of the facility and the like. For example, the identification instructions 618 may utilize one or more machine learned models 632 with respect to the sensor data 630 to determine the identity of the THU, location, and/or assets of a THU as discussed above.

The damage inspection instructions 620 may be configured to process the sensor data 630 to identify damage associated with assets and/or a THU. For example, the damage inspection instructions 630 may detect damage using the machine learned models then compare the damage detected with any known damage to determine if the damage was received while the THU was being moved. In some cases, the damage inspection instructions 630 may also rate the damage, for instance, using a severity rating.

The inventory metric instructions 622 may be configured to process the sensor data 630 to update balances associated with inventory counts, units shipped, units received, and the like.

The reporting instructions 624 may be configured to generate reports, such as reports 114 of FIG. 1 in order to update facility operators and/or third-party systems with respect to the inventory. In some cases, the reporting instructions 624 may include sensor data 630, data associated with the alerts, data associated with vehicle operations, data associated with the inventory metric instructions 622, data associated with the location and tracking instructions 626, and the like.

The location tracking instructions 626 may be configured to track a position and/or location of the inventory throughout the facility. The location tracking instructions 626 may update the location of the inventory each time an asset is identified with respect to and/or moved by a forklift or human, as discussed above.

The alert instructions 628 may be configured to alert or otherwise notify vehicle operators and/or facility operators in response to the sensor data 630, the identification instructions 618, the damage inspection instructions 622, the alignment determining instructions 616, and/or a combination thereof. For example, the alert instructions 628 may cause instructions to be presented to a vehicle operator in response to a misalignment of the implement with the openings of the THU.

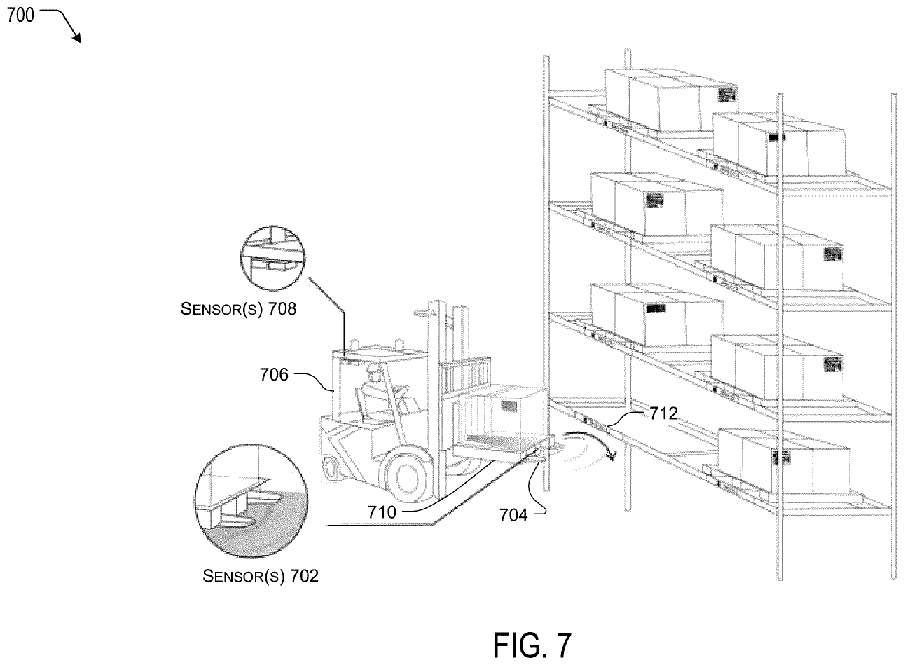

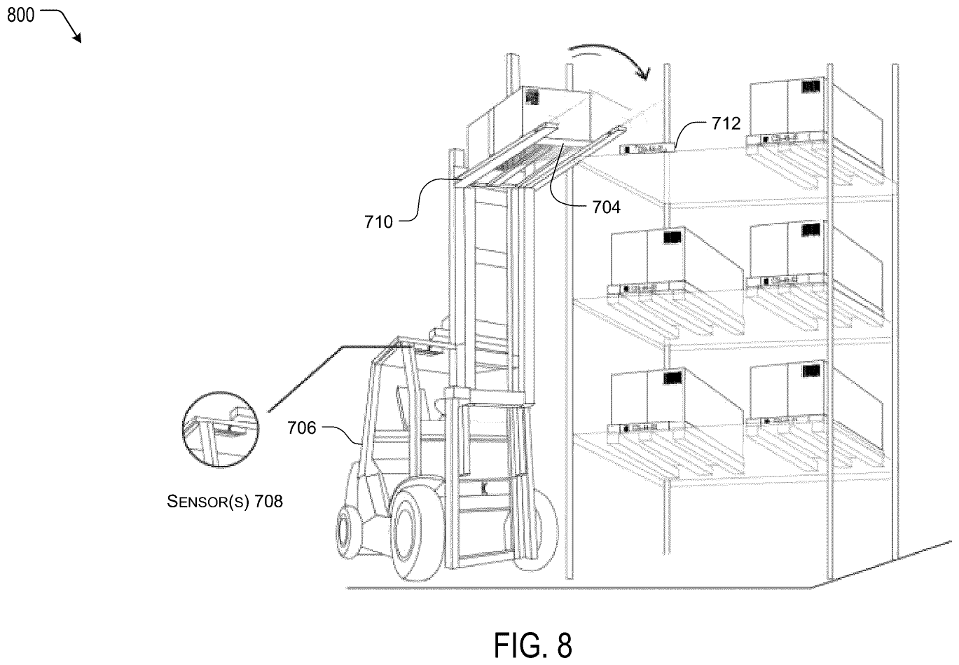

FIGS. 7 and 8 are example pictorial views 700 and 800 associated with the systems of FIGS. 1-6 according to some implementations. In the current example the sensor systems 702 shares a field of view with an implement 704 of the vehicle 706. In this example, a sensor (such as an EDGE computing device 708 in communication with the sensors 702 may either preform the operations of the inventory management system or send (e.g., stream) the sensor data to a central inventory management system or cloud-based service. In this example, the system may determine the operator is picking a THU 710 to the location indicated by the license plate 712 based on a determined direction of travel of the vehicle 706.

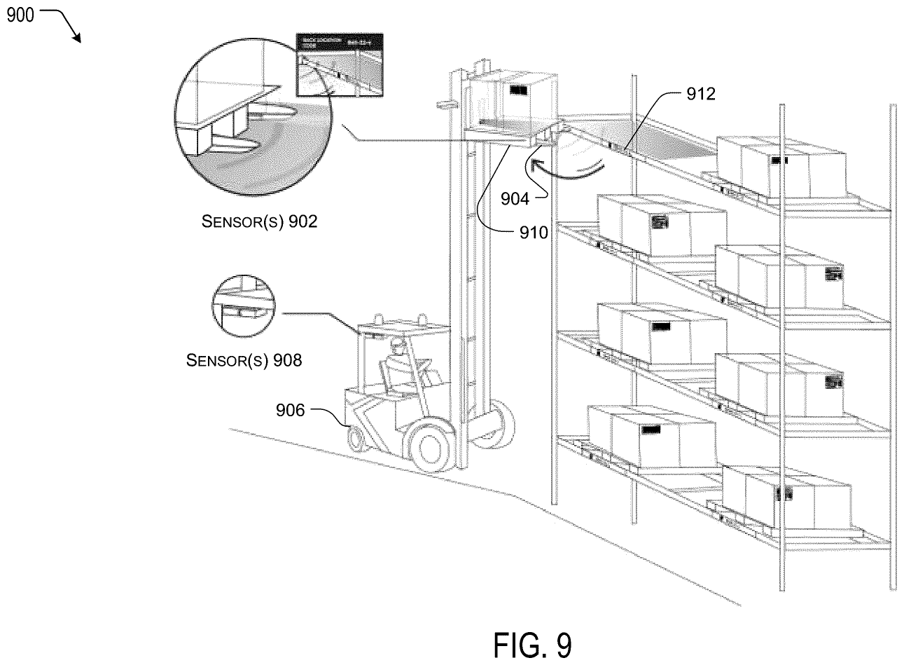

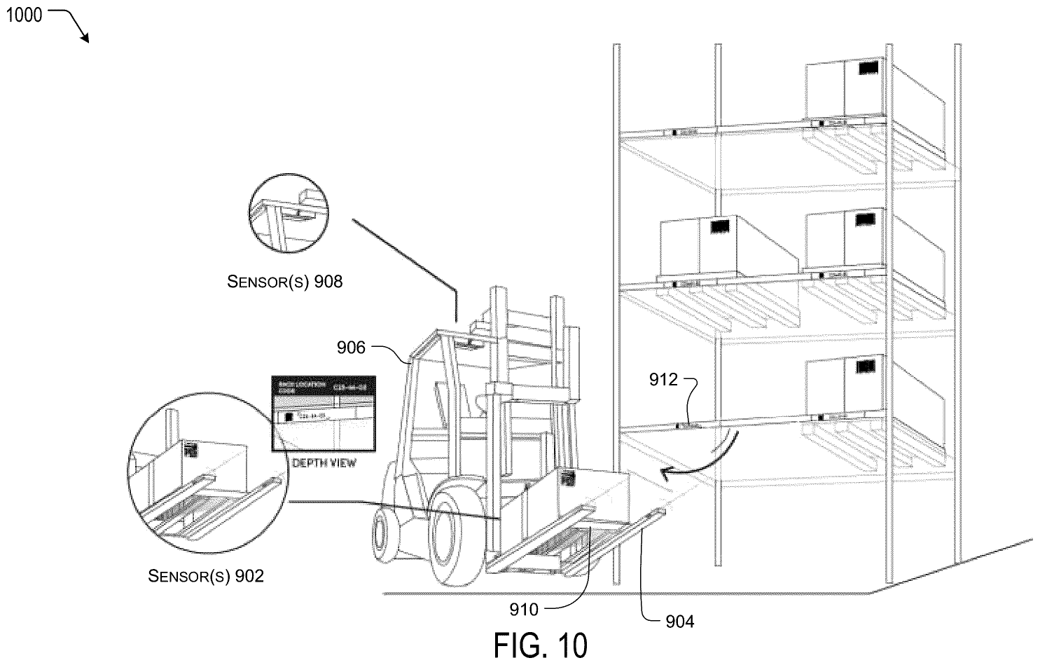

FIGS. 9 and 10 are another example pictorial view 900 and 1000 associated with the systems of FIGS. 1-6 according to some implementations. In the current example the sensor systems 902 shares a field of view with an implement 904 of the vehicle 906. In this example, a sensor (such as an EDGE computing device) 908 in communication with the sensors 902 may either preform the operations of the inventory management system or send (e.g., stream) the sensor data to a central inventory management system or cloud-based service. In this example, the system may determine the operator is delivering a THU 910 to the location indicated by the license plate 912 based on a determined direction of travel of the vehicle 906.

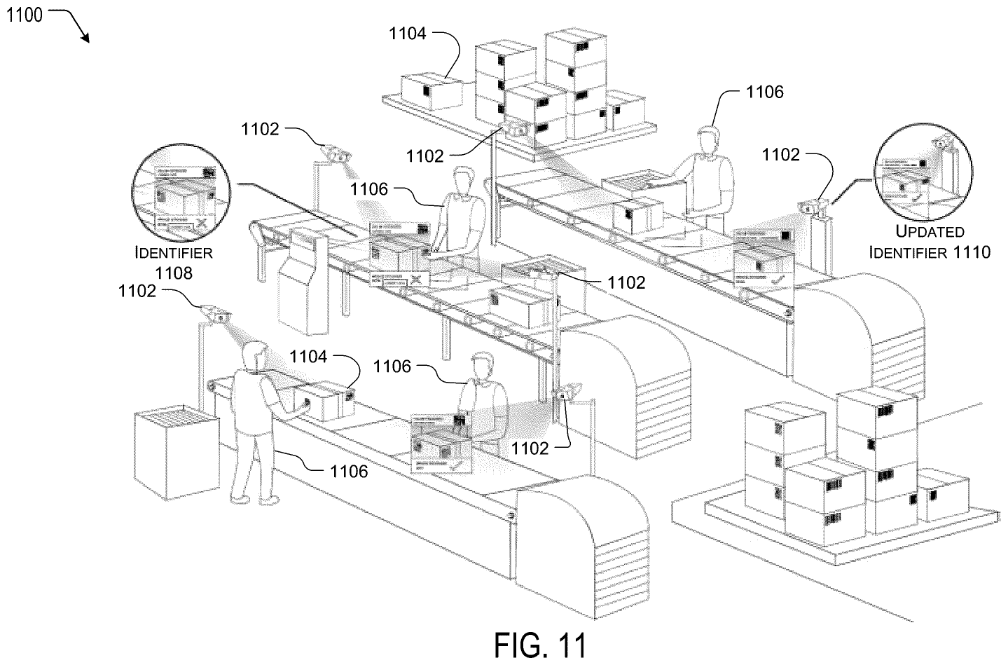

FIG. 11 is another example pictorial view 1100 associated with the systems of FIGS. 1-6 according to some implementations. For instance, in this example, the system may include tower or other mounted sensor systems, generally indicated by 1102, positioned about a processing area or region. The mounted sensor systems 1102 may capture additional sensors data associated with the processing events (e.g., assembly, re-packaging, re-labeling, re-stickering, breakdown, build, and the like). In the current example, the assets, generally indicated by 1104, are being re-labeled or re-stickered by the facility employees, generally indicated by 1106. Thus, the inventory system, discussed herein, may receive sensor data from the mounted sensors 1102 to determine an identity of the asset 1104 prior to the re-labeling event. For example, as illustrated, the sensor data may include images of the identifier 1108. The mounted sensors 1102 may also capture sensor data associated with the re-labeling event and of the new label. The inventory management system may then detect the re-labeling event and the new identity based on the new label or identifier 1110 of the particular asset 1104. The inventory management system may then update the inventory record associated with the asset 1104 with the new identifier or identity. In this manner, as the assets 1104 are processed, the inventory management system may maintain accurate and up to date records. In some cases, the sensors 1104 may also capture sensor data associated with loading the re-labeled assets on a THU to further track the location of the assets 1104.

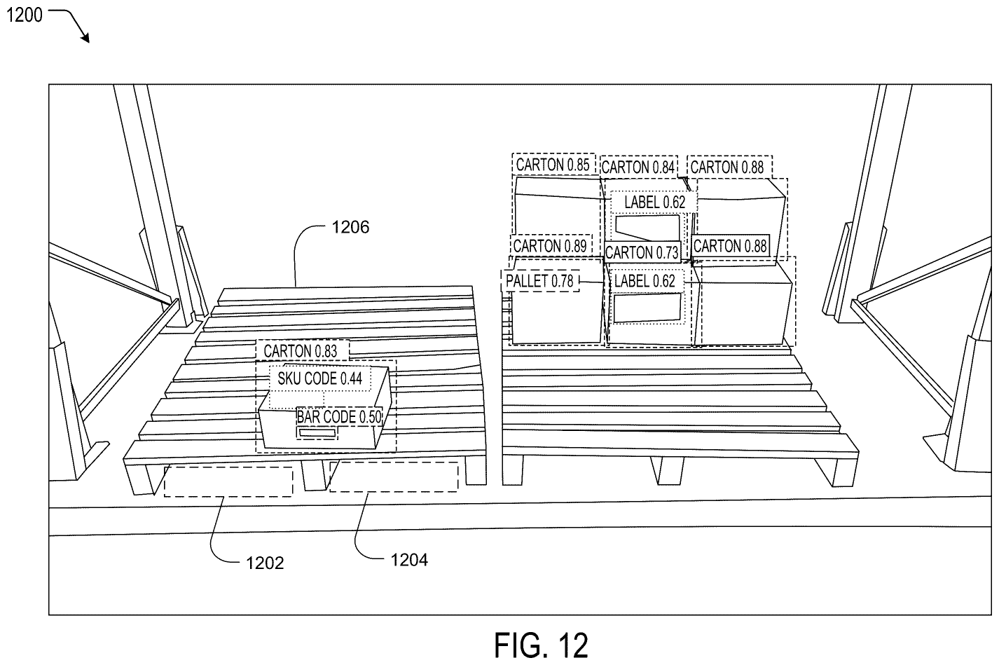

FIG. 12 is another example pictorial view 1200 associated with the systems of FIGS. 1-6 according to some implementations. In the current example, the scene associated with the sensor data is shown. In this example, the inventory management system may detect positions 1202 and 1204 associated with a THU 1206 and determine if the implements (not shown) are properly aligned. The inventory management system may also determine the type of the event (e.g., collection or delivery) based on the sensor data and identify of the various units and THUs as shown.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

### EXAMPLE CLAUSES

A. An system comprising: one or more processors; and one or more non-transitory computer-readable media storing instructions that, when executed by the one or more processors, cause the one or more processors to perform operations comprising: receiving first sensor data associated with a physical environment; determining, based at least in part on the first sensor data, a first type of event associated with the sensor data; determining, based at least in part on the first sensor data, an identity of a transport handling unit; determining, based at least in part on the first sensor data, a first location associated with the transport handling unit; determining, based at least in part on the first sensor data, an alignment between an implement and an opening of the transport handling unit; and updating a record associated with the transport handling unit.
B. The system of claim A, the operations further comprising: receiving second sensor data associated with the physical environment; determining, based at least in part on the second sensor data, a second type of event associated with the sensor data, the second type different than the first type; confirming, based at least in part on the second sensor data, the identity of the transport handling unit; determining, based at least in part on the second sensor data, a second location associated with the transport handling unit; and updating a record associated with the transport handling unit based at least in part on the second location.
C. The system of claims A and B, the operations further comprising: generating a report based at least in part on the record associated with the transport handling unit; and sending the report to a device associated with an operator.
D. The system of claims A-C, the operations further comprising: determining that the alignment may result in an impact associated with the implement; sending, in response to determining that the alignment may result in the impact, an alert to an operator of a vehicle associated with the implement.
E. The system of claims A-E, the operations further comprising: determining the second location does not match an expected location; and sending, in response to determining that the second location does not match the expected location, an alert to an operator of a vehicle associated with the implement.
F. The system of claims A-E, wherein determining the first location or determining the second location is based at least in part on detecting one or more license plates within the first sensor data or the second sensor data.
G. The system of claims A-F, wherein determining the identity of the transport handling unit further comprises determining an identify of at least one asset associated with the transport handling unit.
H. The system of claims A-G, wherein the sensor data is received from a sensor system worn by an operator.
I. The system of claims A-G, wherein the sensor data is received from a sensor system having a field of view associated with the implement.
J. The system of claims A-G, wherein the sensor data is received from a sensor system at a fixed location with respect to a facility.
K. The system of claims A-J, the operations further comprising: receiving third sensor data associated with a physical processing area; determining, based at least in part on the third sensor data, a re-labeling event is in progress; determining, based at least in part on the third sensor data, an identity of an asset based on a first identifier; receiving fourth sensor data associated with the asset; determining, based at least in part on the fourth sensor data, the asset has been re-labeled; determining, based at least in part on the fourth sensor data, a new identity of the asset based on a second identifier; and updating a record associated with the asset.
L. The system of claim K, the operations further comprising: the operations further comprising: determining, based at least in part on the third sensor data, an unloading of the asset from a first THU; determining, based at least in part on the fourth sensor data, a loading of the asset from a second THU; and updating the record associated with the asset based at least in part on an identity of the second THU.

While the example clauses described above are described with respect to one particular implementation, it should be understood that, in the context of this document, the content of the example clauses can also be implemented via a method, device, system, a computer-readable medium, and/or another implementation. Additionally, any of examples may be implemented alone or in combination with any other one or more of the other examples.

1. A method comprising:
receiving first sensor data associated with a physical environment;
determining, based at least in part on the first sensor data, a first type of event associated with the sensor data;
determining, based at least in part on the first sensor data, an identity of a transport handling unit;
determining, based at least in part on the first sensor data, a first location associated with the transport handling unit;
determining, based at least in part on the first sensor data, an alignment between an implement and an opening of the transport handling unit; and
updating a record associated with the transport handling unit.

2. The method of claim 1, further comprising:
receiving second sensor data associated with the physical environment;
determining, based at least in part on the second sensor data, a second type of event associated with the sensor data, the second type different than the first type;
confirming, based at least in part on the second sensor data, the identity of the transport handling unit;
determining, based at least in part on the second sensor data, a second location associated with the transport handling unit; and
updating a record associated with the transport handling unit based at least in part on the second location.

3-15. (canceled)

16. The method of the claim 2, further comprising:
determining the second location does not match an expected location; and
sending, in response to determining that the second location does not match the expected location, an alert to an operator of a vehicle associated with the implement.

17. The method of the claim 2, wherein determining the first location or determining the second location is based at least in part on detecting one or more license plates within the first sensor data or the second sensor data.

18. The method of claim 1, further comprising:
generating a report based at least in part on the record associated with the transport handling unit; and
sending the report to a device associated with an operator.

19. The method of the claim 1, further comprising:
determining that the alignment may result in an impact associated with the implement; and
sending, in response to determining that the alignment may result in the impact, an alert to an operator of a vehicle associated with the implement.

20. The method of the claim 1, wherein determining the identity of the transport handling unit further comprises determining an identify of at least one asset associated with the transport handling unit.

21. The method of the claim 1, wherein the first sensor data is received from a sensor system worn by an operator.

22. The method of the claim 1, wherein the first sensor data is received from a sensor system having a field of view associated with the implement.

23. The method of the claim 1, wherein the first sensor data is received from a sensor system at a fixed location with respect to a facility.

24. The method of the claim 1, further comprising:
receiving second sensor data associated with a physical processing area;
determining, based at least in part on the second sensor data, a re-labeling event is in progress;
determining, based at least in part on the second sensor data, an identity of an asset based on a first identifier;
receiving third sensor data associated with the asset;
determining, based at least in part on the third sensor data, the asset has been re-labeled;
determining, based at least in part on the third sensor data, a new identity of the asset based on a second identifier; and
updating a record associated with the asset based at least in part on the second identifier.

25. The method of the claim 1, further comprising
determining, based at least in part on second sensor data, an unloading of an asset from a first THU;
determining, based at least in part on third sensor data, a loading of the asset from a second THU; and
updating the record associated with the asset based at least in part on an identity of the second THU.

26. A system comprising:
one or more processors; and
one or more non-transitory computer-readable media storing instructions that, when executed by the one or more processors, cause the one or more processors to perform operations comprising:
receiving first sensor data associated with a physical environment;
determining, based at least in part on the first sensor data, a first type of event associated with the sensor data;
determining, based at least in part on the first sensor data, an identity of a transport handling unit;
determining, based at least in part on the first sensor data, a first location associated with the transport handling unit;
determining, based at least in part on the first sensor data, an alignment between an implement and an opening of the transport handling unit; and
updating a record associated with the transport handling unit.

27. The system of claim 26, wherein the operations further comprise:
receiving second sensor data associated with the physical environment;
determining, based at least in part on the second sensor data, a second type of event associated with the sensor data, the second type different than the first type;
confirming, based at least in part on the second sensor data, the identity of the transport handling unit;
determining, based at least in part on the second sensor data, a second location associated with the transport handling unit; and
updating a record associated with the transport handling unit based at least in part on the second location.

28. The system of claim 26, wherein determining the identity of the transport handling unit further comprises inputting the first sensor data into one or more machine learned models and to receive the identity as an output of the one or more machine learned models, the one or more machine learned models configured to segment and classify the sensor data.

29. One or more non-transitory computer-readable media storing instructions that, when executed by one or more processors, cause the one or more processors to perform operations comprising:
receiving first sensor data associated with a physical environment;
determining, based at least in part on the first sensor data, a first type of event associated with the sensor data;
determining, based at least in part on the first sensor data, an identity of a transport handling unit;
determining, based at least in part on the first sensor data, a first location associated with the transport handling unit;
determining, based at least in part on the first sensor data, an alignment between an implement and an opening of the transport handling unit; and
updating a record associated with the transport handling unit.

30. The one or more non-transitory computer-readable media of claim 29, wherein the operations further comprise:
receiving second sensor data associated with the physical environment;
determining, based at least in part on the second sensor data, a second type of event associated with the sensor data, the second type different than the first type;
confirming, based at least in part on the second sensor data, the identity of the transport handling unit;
determining, based at least in part on the second sensor data, a second location associated with the transport handling unit; and
updating a record associated with the transport handling unit based at least in part on the second location.

31. The one or more non-transitory computer-readable media of claim 30, wherein the operations further comprise receiving second sensor data associated with a physical processing area;
receiving third sensor data associated with a physical processing area;
determining, based at least in part on the third sensor data, a re-labeling event is in progress;
determining, based at least in part on the third sensor data, an identity of an asset based on a first identifier;
receiving fourth sensor data associated with the asset;
determining, based at least in part on the fourth sensor data, the asset has been re-labeled;
determining, based at least in part on the fourth sensor data, a new identity of the asset based on a second identifier; and
updating a record associated with the asset.

32. The one or more non-transitory computer-readable media of claim 29,
determining, based at least in part on second sensor data, an unloading of an asset from a first THU;
determining, based at least in part on third sensor data, a loading of the asset from a second THU; and
updating the record associated with the asset based at least in part on an identity of the second THU.

33. The one or more non-transitory computer-readable media of claim 29,
determining that the alignment may result in an impact associated with the implement; and
sending, in response to determining that the alignment may result in the impact, an alert to an operator of a vehicle associated with the implement.
